(19) United States
(12) Patent Application Publication
(10) Pub. No.: US 2006/0119271 A1
(43) Pub. Date: Jun. 8, 2006

(54) Plasma display panel and method of manufacturing the same

(75) Inventor: Soonhak Kim, Daegu (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/280,400

(22) Filed: Nov. 17, 2005

(30) Foreign Application Priority Data
Dec. 7, 2004 (KR) 10-2004-0102695

(51) Int. Cl. H01J 17/49

(52) U.S. Cl. 313/586; 313/587

(57) ABSTRACT

A plasma display panel, and more particularly, to a plasma display panel capable of reducing continuity resistance between transparent electrodes and bus electrodes while simplifying the manufacturing processes of a substrate and a method of manufacturing the same are provided. The plasma display panel comprises transparent electrodes and bus electrodes. A black material comprising electrical anisotropy is arranged between the transparent electrodes and the bus electrodes. The method of manufacturing the plasma display panel comprises the steps of depositing a transparent conductive material on a front substrate to form transparent electrodes and forming a black material layer having anisotropy on the transparent electrodes.

This nonprovisional application claims priority under 35 U.S.C. § 119(a) on Patent Application No. 10-2004-0102695 filed in Republic of Korea on Dec. 7, 2004, the entire contents of which are hereby incorporated by reference.

### BACKGROUND OF THE INVENTION

1. Field of the Invention

The present invention relates to a plasma display panel, and more particularly, to a plasma display panel capable of reducing continuity resistance of transparent electrodes and bus electrodes while simplifying processes of manufacturing a substrate and a method of manufacturing the same.

2. Description of the Background Art

Recently, flat panel displays (FPD) such as liquid crystal displays (LCD), field emission displays (FED), and plasma display panels (PDP) have been actively developed. Among them, PDPs can be easily manufactured due to a simple structure, have high brightness and high emission efficiency, have a memory function and wide view angle of no less than 160°, and can realize a large screen of no less than 40 inches.

FIG. 1 illustrates a discharge cell of a conventional three-electrode AC surface discharge type PDP.

Referring to FIG. 1, a scan electrode 34Y and a sustain electrode 34Z are formed on a front substrate 46 and an address electrode 32X is formed on a rear substrate 44.

A pair of sustain electrodes 34Y and 34Z are formed of transparent electrodes 34a and bus electrodes 34b. The bus electrode 34b is formed of double layers of a black material layer 34i and an electrode material layer 34j.

A front dielectric layer 42 and a protective layer 40 are laminated on the front substrate 46 where the scan electrode 34Y and the sustain electrode 34Z are formed to run parallel with each other. Wall charges generated during plasma discharge are accumulated on the front dielectric layer 42.

The protective layer 40 prevents the front dielectric layer 42 from being damaged by sputtering generated during plasma discharge and improves the discharge efficiency of secondary electrons. Magnesium oxide (MgO) is commonly used as the protective layer 40.

A rear dielectric layer 48 and barrier ribs 38 are formed on a rear substrate 44 where the address electrode 32X is formed. The surfaces of the rear dielectric layer 48 and the barrier ribs 38 are coated with a phosphor layer 36. The address electrode 32X is formed to intersect the scan electrode 34Y and the sustain electrode 34Z.

The barrier ribs 38 are formed to run parallel with the address electrode 32X to prevent the ultraviolet (UV) rays and visible rays generated by discharge from leaking to adjacent discharge cells.

The phosphor layer 36 is excited by the UV rays generated during plasma discharge to generate one of the red (R), green (G), and blue (B) visible rays. An inert gas for discharging gas is implanted into a discharge space provided between the front substrate 46/the rear substrate 44 and the barrier ribs 38.

Black matrices 52 are formed in the front dielectric layer 42 of the PDP to run parallel with the pair of sustain electrodes 34Y and 34Z in order to improve the contrast of a screen.

The black matrices 52 absorb external light and internal transmission light between adjacent discharge cells to improve color saturation and contrast. The black matrices 52 are visible ray absorbents.

The black matrices 52 are formed by mixing conductive material comprising a ruthenium (Ru) based oxide or non-conductive material comprising a cobalt (Co) based oxide with a solvent and a photosensitive resin to have height of about 5 μm using a printing method or a photosensitive method.

A method of manufacturing a front substrate of a PDP using non-conductive black material will be described as follows.

Referring to FIGS. 2A to 2G, transparent conductive material is deposited on the front substrate 46 to pattern the transparent conductive material so that transparent electrodes 34a are formed as illustrated in FIG. 2A. A black material layer 34i having weak conductivity is printed on the front substrate 46 where the transparent electrodes 34a are formed to cover the transparent electrodes 34a as illustrated in FIG. 2B and is dried. Then, a black material layer 61 corresponding to a transmitting unit 60b is exposed using a first photo mask 60 having the transmitting unit 60b and an intercepting unit 60a on the black material layer 34i as illustrated in FIG. 2C.

Then, an electrode material layer 34j is printed on the front substrate 46 where the partially exposed black material layer 34i is formed as illustrated in FIG. 2D and is dried. Then, the black material layer 34i and the electrode material layer 34j that overlap a transmitting unit 70b are exposed using a second photo mask 70 having the transmitting unit 70b and an intercepting unit 70a as illustrated in FIG. 2E. After patterning the exposed black material layer 34i and electrode material layer 34j by a development process, an annealing process is performed to form the bus electrodes 34b and the black matrices 52 as illustrated in FIG. 2F. Here, the bus electrode is formed of double layers of the black material layer 34i and the electrode material layer 34j and the black matrix 52 is formed of a single layer of the black material layer 34i.

The front substrate 46 in which the pair of sustain electrodes 34Y and 34Z and the black matrices 52 are formed is coated with dielectric layer material to form the front dielectric layer 42 as illustrated in FIG. 2G.

Then, the front dielectric layer 42 is coated with MgO that is protective layer material to form the protective layer 40 as illustrated in FIG. 2H.

As described above, when the non-conductive black material is used, it is possible to simplify processes and to reduce expenses. However, resistance between the bus electrodes 34j and the transparent electrodes 34a increases so that continuity resistance deteriorates.

On the other hand, when the conductive black material is used, since resistance between the bus electrodes 34j and the transparent electrodes 34a is small, continuity resistance is high. However, processes of forming the bus electrodes 34j are different from processes of forming the black matrices so that efficiency deteriorates in terms of processes and expenses.

Therefore, methods of reducing resistance between the bus electrodes and the transparent electrodes while simplifying processes and reducing manufacturing expenses are searched for.

### SUMMARY OF THE INVENTION

Accordingly, an object of the present invention is to solve at least the problems and disadvantages of the background art.

It is an object of the present invention to provide a plasma display panel (PDP) capable of improving continuity resistance while simplifying processes and reducing manufacturing expenses.

A plasma display panel according to the present invention comprises transparent electrodes and bus electrodes. A black material having electrical anisotropy is arranged between the transparent electrodes and the bus electrodes.

A method of manufacturing a plasma display panel according to the present invention comprises the steps of depositing a transparent conductive material on a front substrate to form transparent electrodes and forming a black material layer having anisotropy on the transparent electrodes.

According to the method of manufacturing the PDP of the present invention, exposing and development process is performed once on a single sheet in which manufactured black material layer and electrode material layer are integrated with each other to form black matrices and bus electrodes so that manufacturing processes are simplified. Also, since manufacturing processes are simplified, it is possible to prevent the characteristics of devices from deteriorating due to foreign substances such as dust in the air.

### BRIEF DESCRIPTION OF THE DRAWINGS

The present invention will be described in detail with reference to the following drawings in which like numerals refer to like elements.

FIG. 1 is a sectional view illustrating the structure of a discharge cell of a conventional three-electrode AC type PDP.

FIGS. 2A to 2H are sectional views illustrating processes of a method of manufacturing the front substrate of a conventional PDP.

FIGS. 3A to 3F are sectional views illustrating processes of a method of manufacturing the front substrate of a PDP according to the present invention.

FIG. 4 is a perspective view illustrating a pair of sustain electrodes of a PDP according to the present invention.

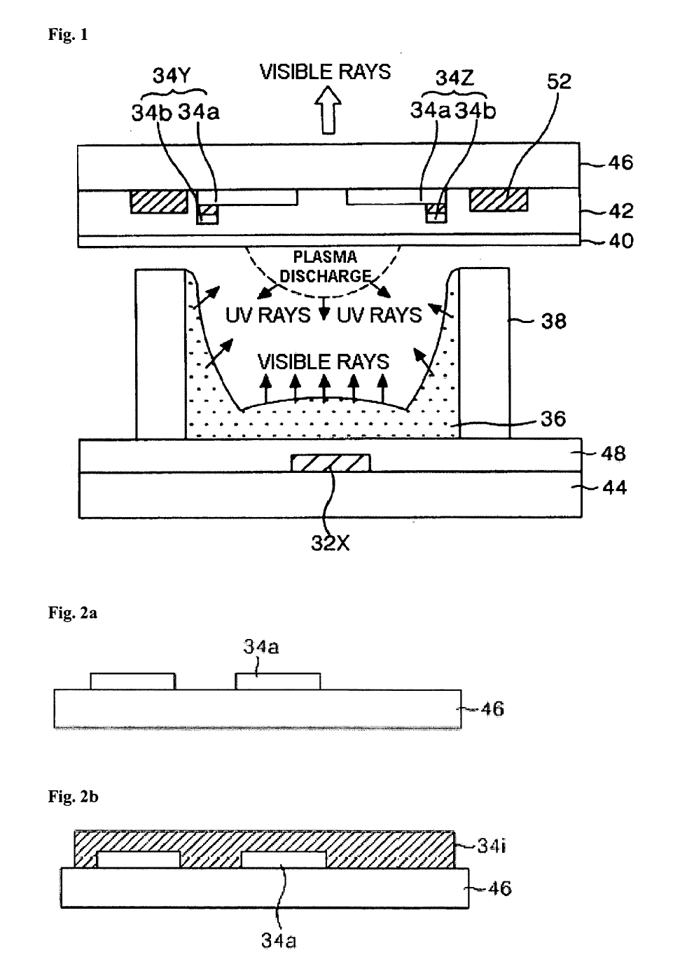

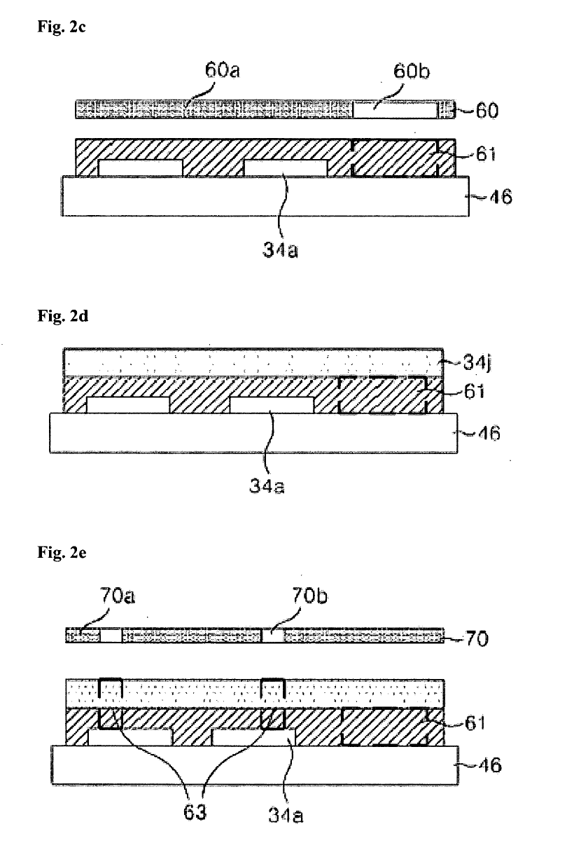

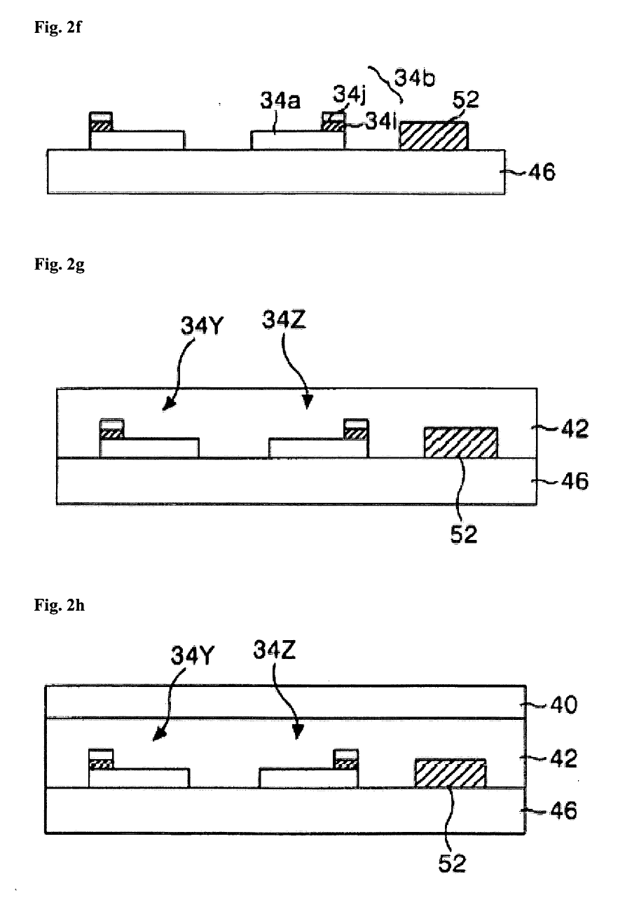

### DETAILED DESCRIPTION OF PREFERRED EMBODIMENTS

Preferred embodiments of the present invention will be described in a more detailed manner with reference to the drawings.

A plasma display panel according to the present invention comprises transparent electrodes and bus electrodes. A black material having electrical anisotropy is arranged between the transparent electrodes and the bus electrodes.

The black material is obtained by adding a conductive metal material or a conductive metal oxide to a non-conductive material.

The conductive metal material or the conductive metal oxide is formed in the form of a ball or a pellet.

The ratio of the conductive metal material or the conductive metal oxide ranges from 5 wt % to 30 wt %.

The conductive metal material or the conductive metal oxide comprises at least one of Au, Ag, Cu and Ru.

The conductive metal material or the conductive metal oxide comprises one of Au+Ag, Au+Cu, Au+Ru, Ag+Cu, Ag+Ru and Cu+Ru.

The conductive metal material or the conductive metal oxide comprises one of Au+Ag+Cu, Au+Ag+Ru, Au+Cu+Ru, Ag+Cu+Ru and Au+Ag+Cu+Ru.

A method of manufacturing a plasma display panel according to the present invention comprises the steps of depositing a transparent conductive material on a front substrate to form transparent electrodes and forming a black material layer having anisotropy on the transparent electrodes.

The step of forming the black material having anisotropy comprises the steps of exposing a black material layer using a first photo mask and exposing a black material layer and an electrode material layer using a second photo mask.

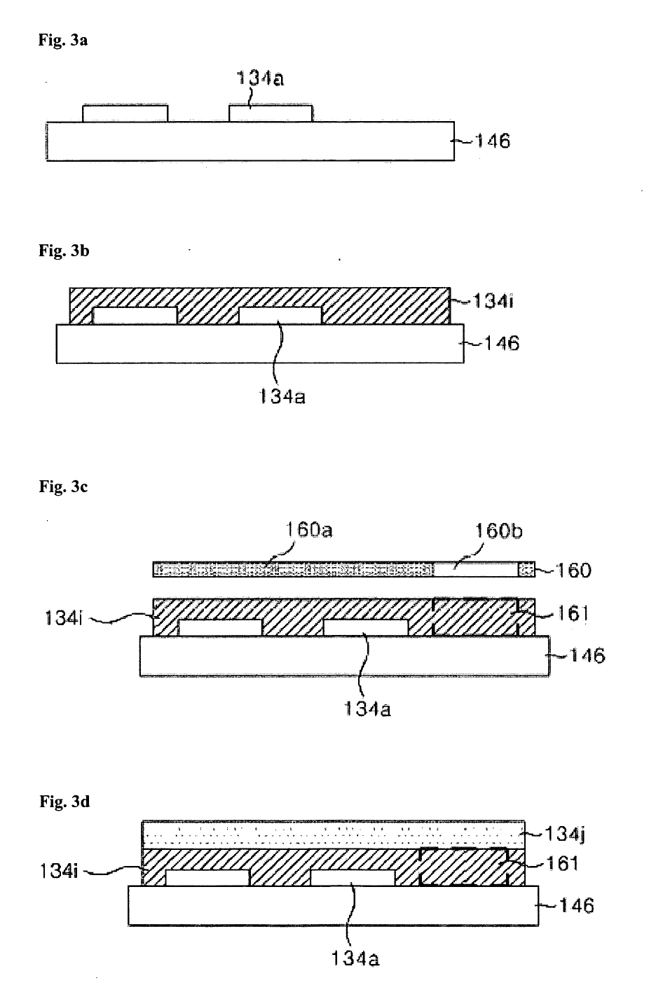

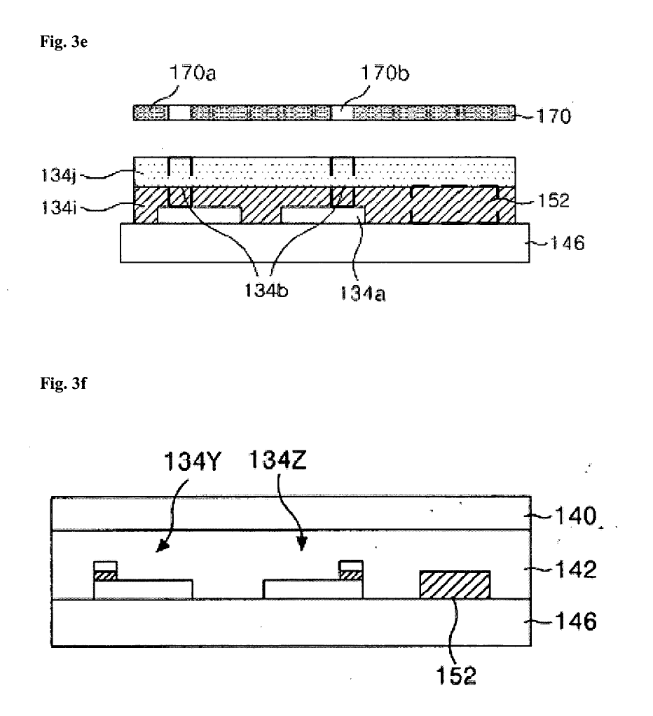

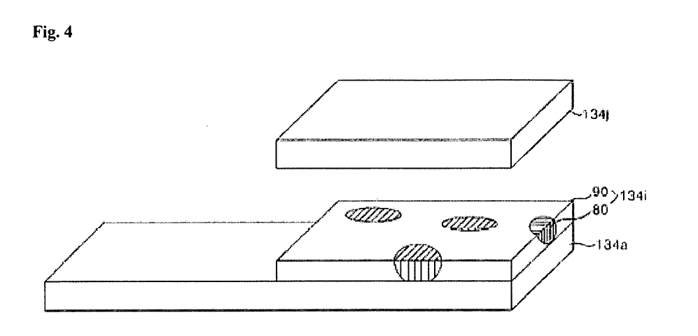

Hereinafter, preferred embodiments of the present invention will be described with reference to FIGS. 3A to 4.

Processes of manufacturing a PDP according to the present invention will be described with reference to FIGS. 3A to 3G.

Referring to FIG. 3A, a transparent conductive material is deposited on a front substrate 146 and is patterned to form transparent electrodes 134a as illustrated in FIG. 3A.

Referring to FIG. 3B, a black material layer 134i is printed on the front substrate 146 on which the transparent electrodes 134a are formed to cover the transparent electrodes 134a as illustrated in FIG. 3B and is dried. Here, the black material layer 134i is an anisotropic black conductor. That is, a material obtained by adding a metal material or a metal oxide such as Au, Ag, Cu and Ru to a non-conductive black material in the form of a ball or a pellet is used. Therefore, it is possible to solve the problem in that the resistance between the transparent electrodes 134a and bus electrodes 134j is large, which occur when only the non-conductive material is used according to the conventional art.

Referring to FIG. 3C, a black material layer 161 corresponding to a transmitting unit 160b is exposed using a first photo mask 160 comprising the transmitting unit 160b and an intercepting unit 160a on the black material layer 134i.

Referring to FIG. 3D, an electrode material layer 134j is printed on the front substrate 146 where the partially exposed black material layer 134i is formed and is dried.

Referring to FIG. 3E, the black material layer 134i and the electrode material layer 134j that overlap a transmitting unit 170b are exposed using a second photo mask 170 having the transmitting unit 170b and an intercepting unit 170a. After the exposed black material layer 134i and electrode material layer 134j are patterned through a development process, an annealing process is performed to form bus electrodes 134b and black matrices 152.

FIG. 4 is a perspective view illustrating the bus electrodes and the transparent electrodes formed using the anisotropic black material layer 134i according to the present invention.

Referring to FIG. 4, the bus electrode 134j and the transparent electrode 134a according to the present invention are formed with the anisotropic black material layer 134i interposed.

The black material layer 134i is manufactured by adding a metal material or a metal oxide 80 to a non-conductive oxide 90 in the form of a ball or a pellet. Au, Ag, Cu, and Ru may be used as the metal material or the metal oxide.

That is, the conductive metal material or the conductive metal oxide comprises at least one of Au, Ag, Cu, and Ru, one of Au+Ag, Au+Cu, Au+Ru, Ag+Cu, Ag+Ru, and Cu+Ru, or one of Au+Ag+Cu, Au+Ag+Ru, Au+Cu+Ru, Ag+Cu+Ru, and Au+Ag+Cu+Ru.

The ratio of the conductive oxide 80 added to the non-conductive oxide 90 in the form of a pellet ranges from 5 wt % to 30 wt %. When the ratio of the conductive oxide 80 is too small, conductivity between the transparent electrodes 134a and the bus electrodes 134j may deteriorate. When the ratio of the conductive oxide 80 is too large, processes are complicated and an anisotropic electric property is not well shown. Therefore, the conductive oxide 80 is added in the ratio of 5 wt % to 30 wt %.

When the front substrate of the PDP according to the present invention is manufactured, the non-conductive oxide 90 is mainly used as the black material layer 134i so that it is possible to simplify processes and to reduce manufacturing expenses. The metal oxide 80 is added to the non-conductive oxide 90 in the form of a pellet so that it is possible to solve the problem in that continuity resistance between the transparent electrodes 134a and the bus electrodes 134j is large, which occur when the black material layer 134i is formed of only the non-conductive oxide 90 according to the conventional art.

According to the conventional art, a high voltage is applied to the electrodes considering drop in voltage. However, it is possible to reduce the magnitude of the voltage applied to the scan electrodes and the sustain electrodes by reducing the continuity resistance. Therefore, it is possible to reduce power consumption that is the biggest disadvantage of a conventional PDP.

The electric property of the black material layer 134i is anisotropy. When the continuity resistance between the transparent electrodes 134a and the bus electrodes 134j is reduced, paths through which current flows are formed on the vertical sections from the transparent electrodes 134a to the bus electrodes 134j so that it is possible to prevent current from flowing through the horizontal section in the black material layer 134i. Therefore, it is possible to reduce voltage loss and to uniformly form a voltage by uniformly distributing the electrodes so that it is possible to improve reliability of discharge.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display panel comprising:
transparent electrodes; and
bus electrodes,
wherein a black material comprising electrical anisotropy is arranged between the transparent electrodes and the bus electrodes.

2. The plasma display panel as claimed in claim 1, wherein the black material is obtained by adding a conductive metal material or a conductive metal oxide to a non-conductive material.

3. The plasma display panel as claimed in claim 2, wherein the conductive metal material or the conductive metal oxide is formed in the form of a ball or a pellet.

4. The plasma display panel as claimed in claim 2, wherein the ratio of the conductive metal material or the conductive metal oxide ranges from 5 wt % to 30 wt %.

5. The plasma display panel as claimed in claim 4, wherein the conductive metal material or the conductive metal oxide comprises at least one of Au, Ag, Cu and Ru.

6. The plasma display panel as claimed in claim 5, wherein the conductive metal material or the conductive metal oxide comprises one of Au+Ag, Au+Cu, Au+Ru, Ag+Cu, Ag+Ru and Cu+Ru.

7. The plasma display panel as claimed in claim 5, wherein the conductive metal material or the conductive metal oxide comprises one of Au+Ag+Cu, Au+Ag+Ru, Au+Cu+Ru, Ag+Cu+Ru and Au+Ag+Cu+Ru.

8. A plasma display panel comprising:
transparent electrodes; and
bus electrodes,
wherein a black material obtained by adding a conductive metal material or a conductive metal oxide to a non-conductive material in the form of a ball or a pellet is provided between the transparent electrodes and the bus electrodes.

9. The plasma display panel as claimed in claim 8, wherein the ratio of the conductive metal material or the conductive metal oxide ranges from 5 wt % to 30 wt %.

10. The plasma display panel as claimed in claim 8, wherein the conductive metal material or the conductive metal oxide comprises at least one of Au, Ag, Cu and Ru.

11. The plasma display panel as claimed in claim 10, wherein the conductive metal material or the conductive metal oxide comprises one of Au+Ag, Au+Cu, Au+Ru, Ag+Cu, Ag+Ru and Cu+Ru.

12. The plasma display panel as claimed in claim 10, wherein the conductive metal material or the conductive metal oxide comprises one of Au+Ag+Cu, Au+Ag+Ru, Au+Cu+Ru, Ag+Cu+Ru and Au+Ag+Cu+Ru.

13. A method of manufacturing a plasma display panel, the method comprising the steps of:
depositing a transparent conductive material on a front substrate to form transparent electrodes; and
forming a black material layer having anisotropy on the transparent electrodes.

14. The method as claimed in claim 13, the step of forming the black material comprising anisotropy comprises the steps of:
exposing a black material layer using a first photo mask; and
exposing a black material layer and an electrode material layer using a second photo mask.

15. The method as claimed in claim 13, wherein the black material is obtained by adding a conductive metal material or a conductive metal oxide to a non-conductive material.

16. The method as claimed in claim 15, wherein the conductive metal material or the conductive metal oxide is formed in the form of a ball or a pellet.

17. The method as claimed in claim 15, wherein the ratio of the conductive metal material or the conductive metal oxide ranges from 5 wt % to 30 wt %.

18. The method as claimed in claim 17, wherein the conductive metal material or the conductive metal oxide comprises at least one of Au, Ag, Cu and Ru.

19. The method as claimed in claim 18, wherein the conductive metal material or the conductive metal oxide comprises one of Au+Ag, Au+Cu, Au+Ru, Ag+Cu, Ag+Ru and Cu+Ru.

20. The method as claimed in claim 18, wherein the conductive metal material or the conductive metal oxide comprises one of Au+Ag+Cu, Au+Ag+Ru, Au+Cu+Ru, Ag+Cu+Ru and Au+Ag+Cu+Ru.
